(19) United States
(12) Patent Application Publication
(10) Pub. No.: US 2019/0318650 A1
(43) Pub. Date: Oct. 17, 2019

(54) METHOD AND APPARATUS FOR LEARNER DIAGNOSIS USING RELIABILITY OF COGNITIVE DIAGNOSTIC MODEL

(71) Applicant: Electronics and Telecommunications Research Institute, Daejeon (KR)

(72) Inventors: Ho Young YOO, Daejeon (KR); Su Woong LEE, Sejong-si (KR); Hyung Keun JEE, Daejeon (KR)

(73) Assignee: Electronics and Telecommunications Research Institute, Daejeon (KR)

(21) Appl. No.: 16/377,624

(22) Filed: Apr. 8, 2019

(30) Foreign Application Priority Data
Apr. 11, 2018 (KR) 10-2018-0042190

(51) Int. Cl. G09B 19/00; G06F 17/18

(52) U.S. Cl. CPC G09B 19/00; G06F 17/18

(57) ABSTRACT

Provided are an apparatus and method for learner diagnosis using reliability of a cognitive diagnostic model, which estimates the reliability of the cognitive diagnostic model that estimates a concept vector (α) of a learner through a Q-matrix regarding a question and an R-matrix regarding a response to a question, the method including assuming a probability (P(X|α)) of a learner response (X) when a concept vector (α) of a learner is given; obtaining a concept pattern-specific probability (P(α|X)) of the learner from the assumed concept vector and learner response of the learner; obtaining an information entropy (H) value of the learner from the concept pattern-specific probability (P(α|X)) of the learner; and obtaining reliability (γ) of an estimated result of a learner-specific concept understanding using the information entropy value of the learner and a number of concepts.

### CROSS-REFERENCE TO RELATED APPLICATION

This application claims priority to and the benefit of Korean Patent Application No. 2018-0042190, filed on Apr. 11, 2018, the disclosure of which is incorporated herein by reference in its entirety.

### BACKGROUND

### 1. Field of the Invention

The present invention relates to a method for learner diagnosis using reliability of a cognitive diagnostic model, and more specifically, to a method of estimating a learner's concept-specific understanding using a cognitive diagnostic model.

### 2. Discussion of Related Art

A cognitive diagnostic model diagnoses the learning ability of a learner from a learner's test response. In this case, the model uses two types of information.

The first is a Q-matrix, which is association information representing which concepts are required to solve questions constituting a test. The second is an R-matrix, which is response information representing whether or not learners correctly answer the questions in the test.

The cognitive diagnostic model maps out and estimates the learner's understanding status on each concept as a stochastic model.

In order to increase the diagnosis accuracy of the cognitive diagnostic model, education experts need to first elaborately design the Q-matrix of the test paper. Then the designed test needs to be given to as many learners as possible so that a large quantity of response information (R matrices) is obtained.

However, since the Q-matrix and the R-matrix vary according to the test, the same level of accuracy is not secured for all tests or all learners.

### SUMMARY OF THE INVENTION

The present invention is directed to providing a method of verifying the accuracy rate of a diagnosis result for each learner by designing reliability of a cognitive diagnostic model.

The present invention is directed to providing a method of estimating a learner's understanding of a concept using designed reliability when a learner takes a test on the same concept several times.

The technical objectives of the present invention are not limited to the above, and other objectives may become apparent to those of ordinary skill in the art based on the following descriptions.

According to an aspect of the present invention, there is provided a method for learner diagnosis using reliability of a cognitive diagnostic model, which estimates the reliability of the cognitive diagnostic model that estimates a concept vector (α) of a learner through a Q-matrix regarding a question and an R-matrix regarding a response to a question, the method including assuming a probability (P(X|α)) of a learner response (X) when a concept vector (α) of a learner is given; obtaining a concept pattern-specific probability (P(α|X)) of the learner from the assumed concept vector and learner response of the learner; obtaining an information entropy (H) value of the learner from the concept pattern-specific probability (P(α|X)) of the learner; and obtaining reliability (γ) of an estimated result of a learner-specific concept understanding using the information entropy value of the learner and a number of concepts.

In response to presence of reliabilities (γ) of estimated results from a plurality of estimations on a learner-specific concept understanding for the learner, an i^{th} reliability may be used as a weighting coefficient for a concept understanding to obtain a concept understanding (α̅ₗ) of an i^{th} learner.

According to another aspect of the present invention, there is provided an apparatus for learner diagnosis using reliability of a cognitive diagnostic model, including: a learner response probability calculation unit configured to assume a probability (P(X|α)) of a learner response (X) when a concept vector (α) of a learner is given; a concept pattern-specific probability calculation unit configured to obtain a concept pattern-specific probability (P(α|X)) of the learner as a posterior probability; a learner information entropy calculation unit configured to obtain an information entropy (H) value of the learner from the concept pattern-specific probability (P(α|X)) of the learner; and a reliability calculation unit configured to obtain reliability (γ) of an estimated result of a learner-specific concept understanding using the information entropy value of the learner and a number of concepts.

The apparatus may include a weight processing unit configured to use an i^{th} reliability as a weighting coefficient for a concept understanding to obtain a concept understanding (α̅ₗ) of an i^{th} learner, in response to presence of reliabilities γ of estimated results from a plurality of estimations on a learner-specific concept understanding for the learner.

### BRIEF DESCRIPTION OF THE DRAWINGS

FIG. 1 is a functional block diagram for describing an apparatus for learner diagnosis using reliability of a cognitive diagnostic model according to an embodiment of the present invention.

FIG. 2 is a functional block diagram for describing an apparatus for verifying an apparatus for learner diagnosis using reliability of a cognitive diagnostic model according to an embodiment of the present invention.

FIG. 3 is a functional block diagram for describing an apparatus for learner diagnosis using reliability of a cognitive diagnostic model according to another embodiment of the present invention.

FIG. 4 is a functional block diagram for describing an apparatus for verifying an apparatus for learner diagnosis using reliability of a cognitive diagnostic model according to another embodiment of the present invention.

FIG. 5 is a flowchart for describing a method for learner diagnosis using reliability of a cognitive diagnostic model according to an embodiment of the present invention.

### DETAILED DESCRIPTION OF EXEMPLARY EMBODIMENTS

Hereinafter, advantages and features of the present invention and manners of achieving them will become readily apparent with reference to descriptions of the following detailed embodiments when considered in conjunction with the accompanying drawings. However, the scope of the present invention is not limited to such embodiments, and the present invention may be realized in various forms. The embodiments to be described below are embodiments provided only to complete the disclosure of the present invention and assist those skilled in the art in fully understanding the scope of the present invention. The present invention is defined only by the scope of the appended claims. Meanwhile, terms used herein are used to aid in the explanation and understanding of the present invention and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof, and do not preclude the presence or addition of one or more other features, integers, steps, operations, elements, components, and/or groups thereof.

Hereinafter, embodiments of the present invention will be described in detail with reference to the accompanying drawings.

Before describing an embodiment of the present invention, a cognitive diagnostic model will be described for the sake of aiding in the understanding of those skilled in the art.

First, the cognitive diagnostic model is a model that estimates a concept vector α of a learner using a Q-matrix, which is a binary matrix indicating a correlation between a question j and a concept, and an R-matrix, which is a binary matrix indicating a correlation between a learner i and a question j, as input.

Here, the Q-matrix in the cognitive diagnostic model is association information representing which concepts are required to solve questions constituting a test, and the R-matrix is response information representing whether or not learners correctly answer each of the questions in the test.

A representative example of the cognitive diagnostic model includes a deterministic input, noisy “and” gate (DINA) model.

The DINA model estimates a concept-specific understanding of each student from information about a group test, and when the number of students taking the test is I, the number of questions is J, and the number of concepts is K, information to be input to the DINA model is largely divided into two types of information.

The first information is a Q-matrix, which is a binary matrix having a size of J×K, indicating which concepts are associated with questions used in the group test, and the second information is a R-matrix, which is a binary matrix having a size of I×J, indicating whether the students correctly answer the questions.

On the basis of the two types of information, the DINA model estimates whether each student understands the concepts and outputs an estimated result as a binary matrix having a size of I×K.

The Q-matrix, as question-to-concept mapping information, is defined by an education expert in advance, and concepts required to solve the questions are defined in detail and the detailed concept is mapped onto each question.

An understanding vector of an i^{th} student with respect to a k^{th} concept, that is, αi, denoting a binary vector, represents a concept-specific understanding of an i^{th} learner, with an element value of one indicating that the corresponding concept is understood by the i^{th} learner and with an element value of zero indicating that the corresponding concept is not understood by the i^{th} learner.

The “AND” gate in the DINA model is based on an assumption that a student needs to know all the concepts that are mapped onto a question to correctly answer the question.

As an element for determining whether an i^{th} student has an ability to solve a j^{th} question, a latent response vector ηᵢⱼ is modeled as Equation 1.

$${η}_{ij} = [ \frac{{\sum }_{k = 1}^{K} {α}_{ik} \times {q}_{jk}}{{\sum }_{k = 1}^{K} {q}_{jk}} ] \qquad [ Equation 1 ]$$

Here, [a] is the maximum integer not exceeding a, and ηᵢⱼ becomes one when the i^{th} learner has an ability to correctly answer the j^{th} question, and zero when the i^{th} learner does not have the ability, in which ηᵢⱼ equals one only when the i^{th} learner knows all the concepts associated with the j^{th} question, and is expressed as Equation 2 below.

$${η}_{ij} = 1 {}^{if and only if } {α}_{ik} = 1 where k ∈ {Ω}_{j} , \\ {Ω}_{j} = \{ k \vert {q}_{jk} = 1 \} \qquad [ Equation 2 ]$$

Herein, qⱼₖ is an element of the Q-matrix representing whether knowledge of a concept k is required to solve a question j, with a value of one indicating the concept is required and with a value of zero indicating that the concept is not required.

k represents the number of all concepts in a corresponding model. αᵢₖ represents whether a learner i understands a concept k, and the above described αᵢ is a vector having αᵢₖ as the vector elements.

The “NOISE” of the DINA model is a noise parameter representing a characteristic of a question and additionally assumes sⱼ to denote a probability of a wrong answer even with a latent response of one, and gⱼ to denote a probability of a correct answer by a random guess even with a latent response of zero. Parameters sⱼ and gⱼ are expressed as Equations 3 and 4 below.

sⱼ=P(Xᵢⱼ=0|ηᵢⱼ=1)[Equation 3]

gⱼ=P(Xᵢⱼ=1|ηᵢⱼ=0) [Equation 4]

Such a question parameter is a unique parameter of a question, and a value of which varies by the question not by the student.

From the assumptions described above, a probability density function for a response Xᵢⱼ of an i^{th} learner is expressed as Equations 5 and 6 when a concept vector of learners is given as α. Whether a response for the i^{th} learner in solving the j^{th} question is correct or wrong is denoted as Xᵢⱼ, with a value of one or zero indicating a correct response or a wrong response, respectively.

$$\begin{matrix}P ( {X}_{ij} = 1 \vert α ) = \{ \begin{matrix}1 - {s}_{j} & when {η}_{ij} = 1 \\ {g}_{j} & when {η}_{ij} = 0\end{matrix} & [ Equation 5 ] \\ P ( {X}_{ij} = 0 \vert α ) = \{ \begin{matrix}{s}_{j} & when {η}_{ij} = 1 \\ 1 - {g}_{j} & when {η}_{ij} = 0\end{matrix} & [ Equation 6 ]\end{matrix}$$

This may be summarized as a single equation below.

P(Xᵢⱼ=1|α)=gⱼ^{1-η}^{ᵢⱼ}(1−sⱼ)^{η}^{ᵢⱼ}[Equation 7]

P(Xᵢⱼ=0|α)=(1−gⱼ)^{1-η}^{ᵢⱼ}sⱼ^{η}^{ᵢⱼ} [Equation 8]

In the DINA model, a concept vector may be estimated using maximum likelihood estimation.

First, with respect to a given concept vector α, assuming that responses Xᵢⱼ are conditionally independent and have the same probability distribution, Equation 9 is obtained.

$$P ( X \vert α ) = {\prod }_{i = 1}^{I} {\prod }_{j = 1}^{J} P ( {X}_{ij} \vert α ) \qquad [ Equation 9 ]$$

From the above, an estimated result of a learner concept vector is obtained by a Bayesian method, as shown in Equation 10 below.

$$\hat{α} = arg {max}_{α} P ( α \vert X ) = arg {max}_{α} P ( X \vert α ) P ( α ) \qquad [ Equation 10 ]$$

An apparatus for learner diagnosis using reliability of a cognitive diagnostic model according to an embodiment of the present invention may, when a concept vector α of a learner is given, design a probability P(X|α) of a learner's response X together with the assumption.

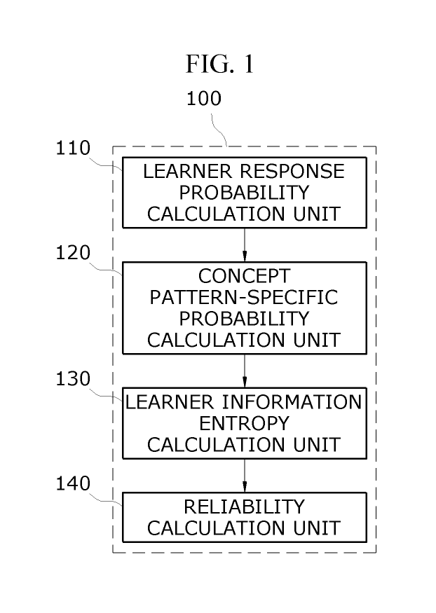

Meanwhile, FIG. 1 is a functional block diagram for describing the apparatus for learner diagnosis using reliability of a cognitive diagnostic model according to the embodiment of the present invention.

As shown in FIG. 1, the apparatus for learner diagnosis using reliability of a cognitive diagnostic model according to the embodiment of the present invention includes a learner response probability calculation unit 110, a concept pattern-specific probability calculation unit 120, a learner information entropy calculation unit 130, and a reliability calculation unit 140.

The learner response probability calculation unit 110 assumes a probability P(X|α) of a learner's response X when a concept vector α of a learner is given, and the concept pattern-specific probability calculation unit 120 obtains a concept pattern-specific probability P(α|X) of the learner, which is a posterior probability, through a Bayesian theorem as shown in Equation 11 below.

$$P ( α \vert X ) = \frac{P ( X \vert α ) P ( α )}{P ( X )} \qquad [ Equation 11 ]$$

Then, the learner information entropy calculation unit 130 obtains a value of an information entropy H of the learner from the concept pattern-specific probability P(α|X) of the learner as shown in Equation 12 below.

Hₗ=−Σ\hat{P}(αᵢ|Xᵢ)·log₂\hat{P}(αᵢ|Xᵢ) [Equation 12]

Here, H denotes an information entropy value, i denotes a learner, and X denotes a learner's response.

Provided that an estimated result of the cognitive diagnostic model is accurate, when the probability distribution of the learner's concept patterns is biased to a certain pattern, the information entropy H approaches zero, and otherwise, the information entropy H increases from zero.

Meanwhile, when all the patterns of concepts possessable by the learner have the same probabilities, the information entropy H has the maximum value. When the number of concepts is ‘k’, the number of patterns of concepts possessable by a learner is 2^{k}, and with P\hat{=}½ⁿ, the maximum value of the information entropy H is equal to the number of concepts k as shown in Equation 13.

$$max H = - {\sum }_{k = 1}^{{2}^{k}} \hat{P} \cdot {log}_{2} \hat{P} = k \qquad [ Equation 13 ]$$

Then, the reliability calculation unit 140 obtains reliability γ of the estimated result of the concept understanding of each learner using the information entropy value of the learner and the number of concepts as shown in Equation 14.

$${γ}_{i} = 1 - \frac{{H}_{i}}{k} , ( 0 \leq {γ}_{i} \leq 1 ) \qquad [ Equation 14 ]$$

Here, γ is the reliability of the estimated result of the concept understanding, i represents a learner, and n is the number of concepts.

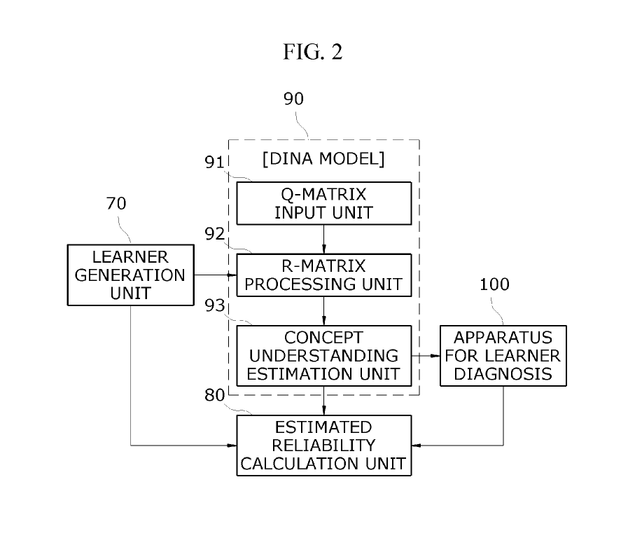

FIG. 2 is a functional block diagram for describing an apparatus for verifying an apparatus for learner diagnosis using reliability of a cognitive diagnostic model according to an embodiment of the present invention.

The apparatus for learner diagnosis using reliability of a cognitive diagnostic model according to the embodiment of the present invention may be verified through a simulation test using the verification apparatus shown in FIG. 2.

First, in order to perform the simulation test, a thousand virtual learners are generated through a learner generation unit 70 (process 1), and virtual test questions are generated through a Q-matrix input unit 91 (process 2). In this case, the Q-matrix used for the test questions is implemented using fraction subtraction data generally used in the related art and is assumed to include eight concepts and thirty questions.

Then, on the basis of the learners generated in process 1 and the test generated in process 2, a learner response is simulated using an R-matrix processing unit 92 of a DINA model 90. In this case, the learners generated through process 1 may be a ground truth.

Then, responses regarding whether the learners generated through process 1 correctly answer the questions generated through process 2 are simulated (process 3).

Then, a learner's concept understanding is estimated, using only the simulated response information according to the conventional method, by a concept understanding estimation unit 93 (process 4).

With respect to the learner's concept understanding estimated as the above, estimated reliability of each learner is calculated through the apparatus 100 for learner diagnosis using reliability of a cognitive diagnostic model according to the embodiment of the present invention (process 5).

In this case, an estimated result of the estimated learner's concept understanding is compared with the reliability estimated using the ground truth of the learner generated in process 1 so that the accuracy of the estimation is calculated (process 6).

Then, the estimated reliability of each learner calculated through the apparatus 100 for learner diagnosis in process 5 is compared with the accuracy of estimation calculated through the estimated reliability calculation unit 80 in process 6 so that a calculated result of a correlation between the two pieces of information, that is, between the estimated reliability of each learner and the accuracy of estimation, is drawn.

Calculating the correlation between the two pieces of information presents a high correlation value of 0.7871.

Accordingly, a positive correlation that higher designed reliability provides a higher estimation accuracy is verified.

As described above, according to the embodiment of the present invention, the proposed reliability has a value between zero and one, with a value approaching zero indicating that the estimated result is unreliable and a value approaching one indicating that the estimated result is reliable so that the reliability may be used as an indicator quantitatively showing the degree to which the diagnosis result for each learner is reliable.

According to another embodiment of the present invention, when a single learner takes the same test multiple times, reliabilities calculated from the respective tests may be used as weighting coefficients.

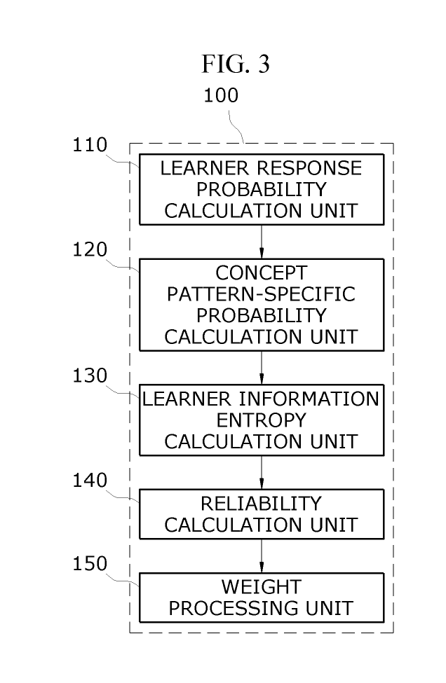

FIG. 3 is a functional block diagram for describing an apparatus for learner diagnosis using reliability of a cognitive diagnostic model according to another embodiment of the present invention.

As shown in FIG. 3, the apparatus for learner diagnosis using reliability of a cognitive diagnostic model according to the embodiment of the present invention includes the components of the apparatus for learner diagnosis according to the previous embodiment, and in order to increase the accuracy of reliability on an estimated result of a concept understanding, further includes a weight processing unit 150 configured to, in response to presence of test data obtained from multiple times of testing, use an estimated concept understanding of an i^{th} learner as a weighting coefficient and obtain a concept understanding of the i^{th} learner using the estimated concept understanding which has been used as the weighting coefficient through Equation 15 shown below.

$$\overline{{α}_{l}} = \frac{{\sum }_{l} {γ}_{l , i} \cdot }{{\sum }_{l} {γ}_{l , i}} . \qquad [ Equation 15 ]$$

As described above, according to the embodiment of the present invention, when a single learner takes a test several times, the reliability calculated from each test may be used as a weighting coefficient so that among estimated results of concept-specific understanding, an estimated result having a higher reliability is given a higher weighting value so that a higher accuracy of estimation is achieved.

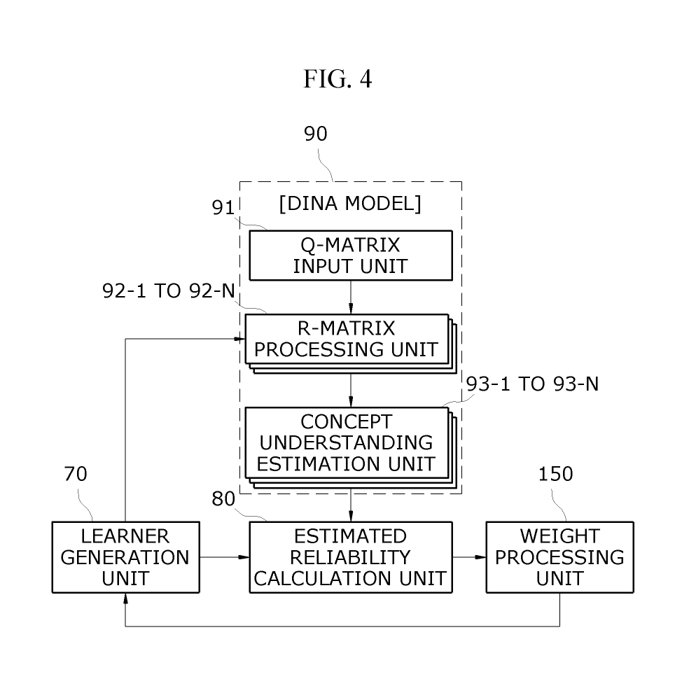

FIG. 4 is a functional block diagram for describing an apparatus for verifying an apparatus for learner diagnosis using reliability of a cognitive diagnostic model according to another embodiment of the present invention.

The following description will be made in relation to a test for verifying the apparatus for learner diagnosis using reliability of a cognitive diagnostic model according to the embodiment of the present invention.

First, a thousand virtual learners and concept vectors are generated through a learner generation unit 70 (process 11), and test question parameters are generated through a Q-matrix input unit 91 (process 12). In this case, the Q-matrix used for the test question parameters may be implemented using fraction subtraction data used in the related art.

Then, on the basis of the information generated in process 11 and process 12, a learner's response is simulated ten times using R-matrix processing units 92-1 to 92-n (process 13). In this case, the R-matrix processing units 92-1 to 92-n may be the same matrix.

Then, a learner's concept understanding is estimated on the basis of each simulated response through concept understanding estimation units 93-1 to 93-n (process 14).

Each reliability is calculated using a corresponding one of the estimated learner's concept understandings through an estimated reliability calculation unit 80 (process 15).

Thereafter, reliability-weighted sum of the estimated results is calculated through the apparatus for learner diagnosis using reliability of a cognitive diagnostic model according to the embodiment of the present invention such that a final learner's understanding is obtained (process 16).

According to the embodiment of the present invention, the ground truth in process 1 is compared with final estimated results of the learner's understanding estimated according to the conventional method.

[Table 1] shows a result of estimation using the apparatus for learner diagnosis using reliability of a cognitive diagnostic model according to the embodiment of the present invention.

TABLE 1

| Simulation number | 1 | 2 | 3 | 4 | 5 | 6 | 7 | 8 | 9 | 10 |
|---|---|---|---|---|---|---|---|---|---|---|
| Conventional | 70.14 | 69.98 | 71.03 | 70.32 | 69.38 | 70.16 | 70.32 | 70.28 | 69.08 | 69.71 |

| | |
|---|---|
| Proposed | 74.74 |

The estimated results according to the previous embodiment have an accuracy of 70.04% on average.

Among the ten simulation results, the third simulation result has a high accuracy of 71.03%, which is lower than the accuracy of the estimated result obtained through the embodiment of 74.74%.

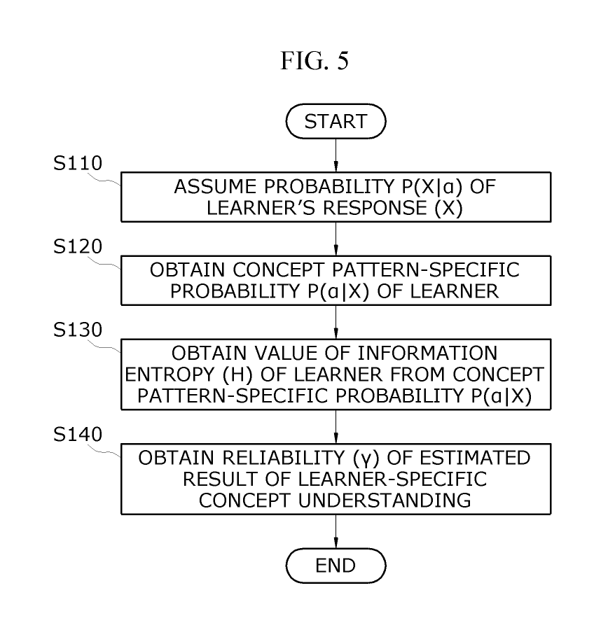

Hereinafter, a method of learner diagnosis using reliability of a cognitive diagnostic model according to an embodiment of the present invention will be described with reference to FIG. 5.

FIG. 5 is a flowchart for describing the method for learner diagnosis using reliability of a cognitive diagnostic model according to the embodiment of the present invention.

A probability P(X|α) of a learner's response X is assumed when a concept vector α of a learner is given through an apparatus for estimating reliability of a cognitive diagnostic model that estimate a learner's concept vector α using a Q-matrix (a matrix regarding a question) and an R-matrix (a matrix regarding a response) as input (S110), and a concept pattern-specific probability P(α|X) of the learner, which is a posterior probability, is obtained through the concept pattern-specific probability calculation unit 120 using the Bayesian theorem as shown in Equation 11 (S120).

Then, a value of an information entropy H of the learner is obtained from the concept pattern-specific probability P(α|X) of the learner through the learner information entropy calculation unit 130 as shown in Equation 12 (S130). Provided that an estimated result of the cognitive diagnostic model is correct, when the probability distribution of the learner's concept patterns is biased to a certain pattern, the information entropy H approaches zero, and otherwise, the information entropy H increases from zero.

Meanwhile, when all the patterns of concepts possessable by the learner have the same probabilities, the information entropy H has the maximum value. When the number of concepts is ‘k’, the number of patterns of concepts possessable by a learner is 2^{k}, and with P\hat{=}½ⁿ, the maximum value of the information entropy H is equal to the number of concepts k, as shown in Equation 13.

Then, the reliability calculation unit 140 obtains reliability γ of the estimated result of the concept understanding of each learner using the information entropy value of the learner and the number of concepts as shown in Equation 14 (S140).

The apparatus for learner diagnosis and method using reliability of a cognitive diagnostic model according to the embodiment of the present invention, in order to increase the accuracy of reliability on an estimated result of a concept understanding, is configured to, in response to the presence of test data obtained from multiple times of testing, use an estimated concept understanding of an i^{th} learner as a weighting coefficient and obtain a concept understanding of the i^{th} learner using the estimated concept understanding which has been used as the weighting coefficient, as shown in Equation 15.

As is apparent from the above, the proposed reliability has a value ranging from zero to one with a value approaching zero indicating that the estimated result is unreliable and a value approaching one indicating that the estimated result is reliable so that the proposed reliability can be used as an indicator quantitatively showing how the diagnosis result for each learner is reliable.

Although the present invention has been described with reference to the accompanying drawings for illustrative purposes, it should be appreciated by those skilled in the art that various modifications, equivalents, and other embodiments are possible without departing from the scope and sprit of the present invention. Therefore, the scope of the present invention is defined by the appended claims of the present invention.

What is claimed is:

1. A method for learner diagnosis using reliability of a cognitive diagnostic model, which estimates the reliability of the cognitive diagnostic model that estimates a concept vector (α) of a learner through a Q-matrix regarding a question and an R-matrix regarding a response to a question, the method comprising:
assuming a probability (P(X|α)) of a learner response (X) when a concept vector (α) of a learner is given;
obtaining a concept pattern-specific probability (P(α|X)) of the learner from the assumed concept vector and learner response of the learner;
obtaining an information entropy (H) value of the learner from the concept pattern-specific probability (P(α|X)) of the learner; and
obtaining reliability (γ) of an estimated result of a learner-specific concept understanding using the information entropy value of the learner and a number of concepts.

2. The method for learner diagnosis of claim 1, wherein the obtaining of the concept pattern-specific probability (P(α|X)) of the learner is achieved using a Bayesian theorem.

3. The method for learner diagnosis of claim 1, wherein the obtaining of the information entropy (H) of the learner is achieved using an expectation-maximization (EM) algorithm or a Markov chain Monte Carlo (MCMC) algorithm.

4. The method for learner diagnosis of claim 1, wherein, in response to presence of reliabilities (γ) of estimated results from a plurality of estimations on a learner-specific concept understanding for the learner, an i^{th} reliability is used as a weighting coefficient for a concept understanding to obtain a concept understanding (α̅₁) of an i^{th} learner.

5. An apparatus for learner diagnosis using reliability of a cognitive diagnostic model, comprising:
a learner response probability calculation unit configured to assume a probability (P(X|α)) of a learner response (X) when a concept vector (α) of a learner is given;
a concept pattern-specific probability calculation unit configured to obtain a concept pattern-specific probability (P(α|X)) of the learner as a posterior probability;
a learner information entropy calculation unit configured to obtain an information entropy (H) value of the learner from the concept pattern-specific probability (P(α|X)) of the learner; and
a reliability calculation unit configured to obtain reliability (γ) of an estimated result of a learner-specific concept understanding using the information entropy value of the learner and a number of concepts.

6. The apparatus of claim 5, wherein the learner response probability calculation unit uses a Bayesian theorem.

7. The apparatus of claim 5, wherein the learner information entropy calculation unit uses an expectation-maximization (EM) algorithm or a Markov chain Monte Carlo (MCMC) algorithm.

8. The apparatus of claim 5, further comprising a weight processing unit configured to use an i^{th} reliability as a weighting coefficient for a concept understanding to obtain a concept understanding (α̅ₗ) of an i^{th} learner, in response to presence of reliabilities γ of estimated results from a plurality of estimations on a learner-specific concept understanding for the learner.
